(19) United States
(12) Patent Application Publication
(10) Pub. No.: US 2001/0049616 A1
(43) Pub. Date: Dec. 6, 2001

(54) Group funding forum for networked computer systems

(76) Inventors: Mbuyi N. Khuzadi, Costa Mesa, CA (US); John J. Brodoff, Costa Mesa, CA (US)

Correspondence Address: NEAL M COHEN, 2424 SE BRISTOL STREET, SUITE 300, NEWPORT BEACH, CA, 92660

(21) Appl. No.: 09/745,089

(22) Filed: Dec. 20, 2000

Related U.S. Application Data
(60) Provisional application No. 60/171,473, filed on Dec. 22, 1999.

(51) Int. Cl. G06F 17/60

(52) U.S. Cl. 705/8

(57) ABSTRACT

A system for enabling a series of individual actions that together finance and complete a group action. The system includes a project forum that presents the user with specific projects requiring monetary support, a sub-system that facilitates individual support of projects of interest, a sub-system for monitoring progress of the projects, and a sub-system for developing interest in the specific project. The system facilitates raising funds to complete different projects that will lead to a specific end. Support structures are provided for finding and easily supporting projects placed on a site embodying the system. An apparatus is included for conducting directed notification about the projects at various stages of completion. A verification protocol is provided for active determination and verification of issue posting individuals and organizations.

### RELATED APPLICATIONS

Applicants of the present application claim priority to provisional U.S. patent application Serial No. 60/171,473, filed Dec. 22, 1999, the contents of which are hereby incorporated herein by reference.

### BACKGROUND OF THE INVENTION

1. Field of the Invention

The present invention relates to group action for the completion of projects, purchase of products and services, and computerized group decision making in which a monetary or similar method supports the decision.

2. Background (Prior Art)

General group action at the time of the present invention exists in a very common form in the public sector. It occurs in many areas of society (e.g., commerce, social action, and government) and represents a pivotal method for innovation of all types. Group action allows individuals and organizations to choose, with those that comprise the “group”, to accomplish a specific action or project. In most settings, this process is captured through either arduous negotiation, general consent, or some form of democratic or representative vote. An example would be the decision of a single town to build a recreation center within its jurisdiction. In such a case the group (community) decision is made through a representative vote within the community.

Historically, the group action has endeavored to accomplish different social or economic goals. It has been, in large part, limited to private actions, government actions, and a limited number of quasi-private actions. By private action we mean, for instance, one in which a group of friends or family members join together to make a purchase or throw a party. In the truest sense, the group conceived of the idea, handled any required financing of the idea, and completed it. The completion of group action, in these cases, resulted in a new purchase or a personal party. In government, through different methods of representation, laws are drafted and enforced, community programs or infrastructure such as the police or fire department are established and supported, and community goods projects are completed. In more controlled group actions, foundations are established to support specific corporate interests or funds are raised for a plethora of non-profit funded activities.

In each of these cases, the common thread involves the definition and completion of the action in question. The group works through a decision process as to whether or not to complete a specific action, and the group follows through the decision with the proper backing and funding to adequately implement the agreed upon plan. However, this simplistic group action scenario is lacking in several areas that the present invention addresses.

When a group action (such as those discussed above) occurs, the implicit assumption is that the members of the group have intimate knowledge of at least as much of the decision as they need to make it. In most cases, this involves individuals in both the decision to complete a project and the decision to fund the project. The first and third cases are unique in that the decision is made by involved individuals through both their agreement with and contribution to the project. In the second example, funding can be required of individuals and organizations for specific projects even if the projects are not endorsed by those required to fund them.

Group actions start with ideas of individuals or groups of people and then expand into the complete group action. In order for an idea to flourish in this manner, it is necessary for individuals or organizations that have specific ideas to be able to “spread the word” to gather support for the idea. Presently, there is no accepted medium for individuals or small organizations with limited funds or visibility to do so. Moreover, there is no reliable way to inform large numbers of people that would most likely be interested in a specific idea or project.

In the non-profit or governmental models, vast amounts of funds can be committed to a specific project in order to complete it before the project is fully funded. Moreover, there may be a change in commitment to the project by those that are funding it, causing it to be cancelled or abandoned. Alternately, an organization that is gathering funds for a specific project may not be able to gather all the funds necessary to complete the project in the initial fundraising drive. In order to finish the project, organizations often will spend some of the initially contributed funds to support a second drive, which may or may not be successful.

In addition, while philanthropic donations are well established in popular culture, it is exceedingly difficult to find support for projects sponsored by organizations that are not known already. There exist Internet sites and other information repositories that allow “passthrough” donations online or top-level information about an organization, but in order to support an organization, individuals and organizations generally learn about the specific projects that a prospect organization is presently addressing. Thus, the general search engines and repositories are inadequate for searches for regional projects or specific endeavors of interest.

Moreover, in much of the non-profit fundraising world, there is a very limited accountability to complete projects as advertised. While this has not produced a problem raising funds, there is still the possibility of money being used for other purposes than that for which it was raised. The lack of guarantee can become a hindrance for supporters of different organizations or projects.

### SUMMARY OF THE INVENTION

The present invention proposes an answer to several basic needs of individuals and organizations that desire to both propose and support group action.

The present invention provides methods and apparatus to locate, rally, and put together support for regional, interest, or other types of group action projects in such a way as to provide the funds to complete the projects. The projects are promoted by an individual or association of individuals whose interest is to see the project completed. Some examples of such an association are non-profit or political organizations. The projects are completed with the support of other individuals so self-identified as supporters of the project or idea who provide, through non-compulsory but irrevocable support grants, the funds required to complete the project.

The present invention provides an electronic forum (e.g., a user interface on a website or other location accessible via the Internet, an intra-net, a local or wide area network, or any other networked computer system) through which individuals and organizations may selectively post project ideas/issues for funding by the general public. The forum provides a unique format that facilitates finding projects of interest to the user and allows simple browsing of projects seeking funding from the general public. By creating the forum through which projects are posted and supported, value is added because users are no longer required to search for specific activities of organizations who address unique concerns. Thus, users can find the projects they would most like to support easily and effectively.

Another aspect of the present invention is an apparatus that allows large numbers of users to support issues/projects of substantial dollar value with very small support amounts, which, when added together, fully funds the project. These issues are supported through a three-tier process that involves the creation of a user account, the depositing of funds into the account, and the assignment of those funds to specific projects on the site. The ease and versatility through which users assign funds allow issue posters to request support amounts as small as one cent or as large as they want. This allows a great multitude of supporters to successfully fund a project without any person being required to support a substantial part of the complete amount.

Projects placed on the site are posted with specific goals for closure, generally relating the amount of support that a project requires. This can be any number of means of support such as simple number of equal fund amounts or tiered support. The support, for instance, may be monetary, supporter vote, or donation based. These projects are “open” as the support is gathered from users of the site. The projects “close” typically as a result of one of two occurrences. 1) That all requested support is received. In such a case, all of the monies are gathered from the supporters and dispersed to the issue posting individual or organization. 2) The posting period expires (i.e., an end date associated with the issue has arrived). In this case, the issue has remained on the site without gathering enough support for long enough to expire or time out. In such a case, the funds are all returned to the supporters and no monies are paid to the issue posting organization. This process is called the group decision and refers to the above technique that removes risk for supporting any specific issue or issues.

Another aspect of the present invention includes an apparatus for compiling an interest-group based notification list that adds substantial value to the group decision forum. The notification list allows issue posting individuals or organizations to easily notify those that would be most likely to support the issues placed on the site of the placement of new issues. In doing so, persons notified through the operation of the notification list are invited immediately to participate in the issue and thus fund and complete the project.

The present invention also provides a method and apparatus for verifying to varying extents the information provided from the issue posting individual or organization in order to verify the credibility of the issue poster and stimulate support for the project. The provided information, as well as additional information associated therewith (e.g., derived from the provided information, or obtained from a secondary source such as a proprietary database) may be referred to as posting data, but the data may be stored, e.g., as part of that individual's or organization's member data in the member database. The verification process may result in a rejection, or an acceptance, and the acceptance may have a verification status or ranking level associated therewith, such as a number, a quantity of “stars”, or some other level in some other corresponding ranking system. The rank or status may be quantitative or qualitative. This aspect of the present invention is useful to reduce the risk that an issue is posted by an unscrupulous individual or organization that does not intend to complete the stated project. This may occur, for example, by verification of credentials and other organizational qualifiers and the execution of written agreements.

Thus, in a preferred embodiment of the present invention, there are four general features or components:—the forum that simplifies finding issues on the site; the group decision support gathering process; the interest identified notification list mechanism; and the verification of issue posting individuals or organizations to foster growing issue trust. Though some of these features of a preferred embodiment of the present invention are not essential to the present invention, as will be more apparent in reviewing the Detailed Description and claims which follow, in combination these features form a powerful group aggregation and action technology.

In a typical scenario in accordance with the present invention, an issue-based funding forum is accessible to members over a computer network (e.g., the Internet), and is controlled by software running at the network server. The server receives a request from a first member to post an issue on the forum, and the server then executes a posting transaction which in fact posts the issue, and accordingly assigns a funding account to the issue. A second member then accesses the forum, and decides to fund the issue posted by the first member. The server then receives a request from second member to fund the issue, and the server then executes a funding or credit transaction which credits or funds the account. This is repeated for various members, and various issues, throughout the forum.

Funding Seekers' Solved Problems

The individual or organization seeking funding typically has two general needs. The first is how to raise the money that he is looking for to fund the specific needs that he is trying to solve. The second is how to increase his base in order to allow him to find supportive individuals or organizations more quickly. Both of these needs are addressed by the present invention.

The first need is addressed through a system for the individual or organization to participate in an issue forum through a group decision format. The individual or organization may selectively post issues (projects) on the forum at any time. Once posted, an issue allows users and visitors to the site to find these projects easily when they are subject materials that interest them. Because the viewers of the specific issues are interested in the subject material of what they look at, they are more readily able to support issues that have been placed on the site already. This mechanism gathers support for the issues from an engaged audience.

In addition to gathering support for the issue, the present invention will enhance a posting organization's ability to augment their own constituency list through the mechanism that gathers support constituent personal information. This information may be made available to the posting organization in order to allow these organizations to contact such supporters for legal obligation satisfaction as well as further support campaigns.

Funders' Solved Problems

One of the primary goals of a supporter of a community group, political candidate, or non-profit is to find specific projects or goals that they can support. These projects or goals will ultimately enhance their personal position with regard to their wants and needs for themselves and their community. Some of these are rationalized and encouraged by the fact that a number of the donations are given as tax-deductible contributions which enhance the financial position of the giver. In order to find organizations addressing their interests, users generally resort to those that they know or to search engines on the Internet that describe in very brief summary a long list of organizations that one may support. In order to be sure that the organization is one that should be supported, it is still necessary for the individual to check into the specific programs that each organization provides.

The group decision forum of the present invention removes the guesswork through the presentation in a simple tree fashion of very specific projects that one may support. The projects are linked to the posting organization's web site, when desired, to allow the user to learn much more about the organization itself. In addition, the forum represents how much support an issue receives to help build momentum to grow and complete a project.

### BRIEF DESCRIPTION OF THE DRAWINGS

FIG. 1 is a simplified diagrammatic representation of traditional prior art fundraising models.

FIG. 2 is a high-level block diagram of a preferred embodiment of the fundraising process of the present invention.

FIG. 3 is a high-level system diagram of a typical hardware configuration used to implement the concepts of the present invention.

FIG. 4 is a flow diagram illustrating the steps for posting and funding a project in accordance with a preferred embodiment of the present invention.

FIG. 5 is a flow diagram illustrating the steps taken in funding a project in accordance with a preferred embodiment of the present invention, from the perspective of a user of the present invention.

FIG. 6 is a flow diagram illustrating maintenance of a specific user account in accordance with a preferred embodiment of the present invention. FIG. 7 is a diagram illustrating some of the concepts involved in posting an issue.

FIG. 8 is a high-level diagram illustrating verification procedures and protocols in accordance with a preferred embodiment of the present invention.

FIG. 9 is a high-level diagram illustrating a design of the general notification mechanism intended to keep clients and supporters engaged in the listed projects and informed as to their successes.

### DETAILED DESCRIPTION

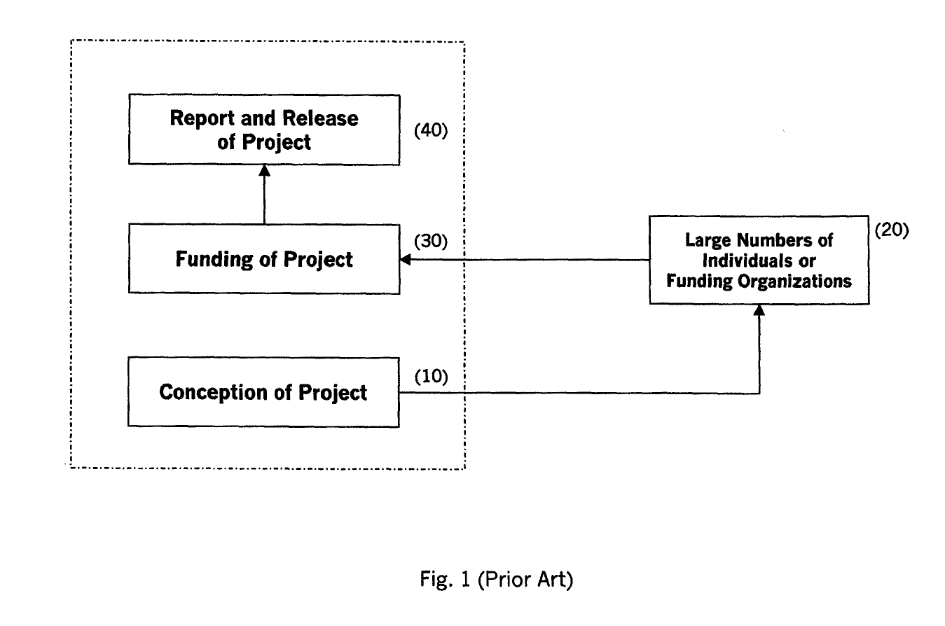

Referring now to the drawings, FIG. 1 illustrates the general form of fundraising used by traditional fundraisers today. A fundraising organization raises funds for specific projects or outcomes that it wants to promote. The fundraising consists of gathering monies from individuals who will support the project and who have a desire to see it completed. An individual may be a natural person or other entity, and is also referred to herein interchangeably with a member, who is simply an individual participating in a forum in accordance with the present invention. In most cases there are several specific steps associated with this operation.

First, the organization conceives the project, as seen at 10. The organization decides on a set of actions to be taken relating to a project. These actions may consist, for instance, of deciding a specific community-visible event to execute or simply a general advocacy concentration. In the course of doing so, the organization decides upon a set of specific actions that a constituency group can use to support it.

Next, the organization solicits funds, as seen at 20. The organization identifies its constituent base and communicates to them through some general media (usually mail or telephone) about the organization's goals. Constituent contacts import knowledge about the overall direction of the organization for further support.

The organization then promotes its focus points and contacts all of its constituency for support of specific endeavors and general funding requests. Through generic means it raises as much money as possible from individual constituents in order to complete whatever projects have been decided upon.

Next, the organization receives funds as seen at 30. Once the funds have been gathered and assuming that there are enough funds to complete the project, the project is completed and the constituency is appraised of the final outcome of the project, as seen at 40. If there is not enough money to complete the process, the funding process starts over again, with the expenditure of some of the raised funds, and the organization attempts to reach the required funding goals. In the event that more funds cannot be raised, they make the best of what they have to complete the project (10).

The traditional model has some important drawbacks that are addressed by the present invention. First, in a traditional fundraising model, most of the constituents need to be informed individually through a regular means such as mail or telephone. Such notification is required due to the absence of a forum from which “general” constituents can learn or be actively delivered information regarding different groups they may support. The resulting cost for this notification and solicitation process can come to 40-50% of the raised budget, detracting from the organization's original purpose. Also, the final support amount is non-deterministic, owing to the variable nature of giving with respect to personal preference, etc. Also, the range of topics that any one organization can address must be focused, making it even more difficult for any one organization to receive the funding it needs to operate and grow. Simply, as shown in FIG. 1, the requirement for and cost of communicating with constituents and collecting funding from them falls directly on the organization.

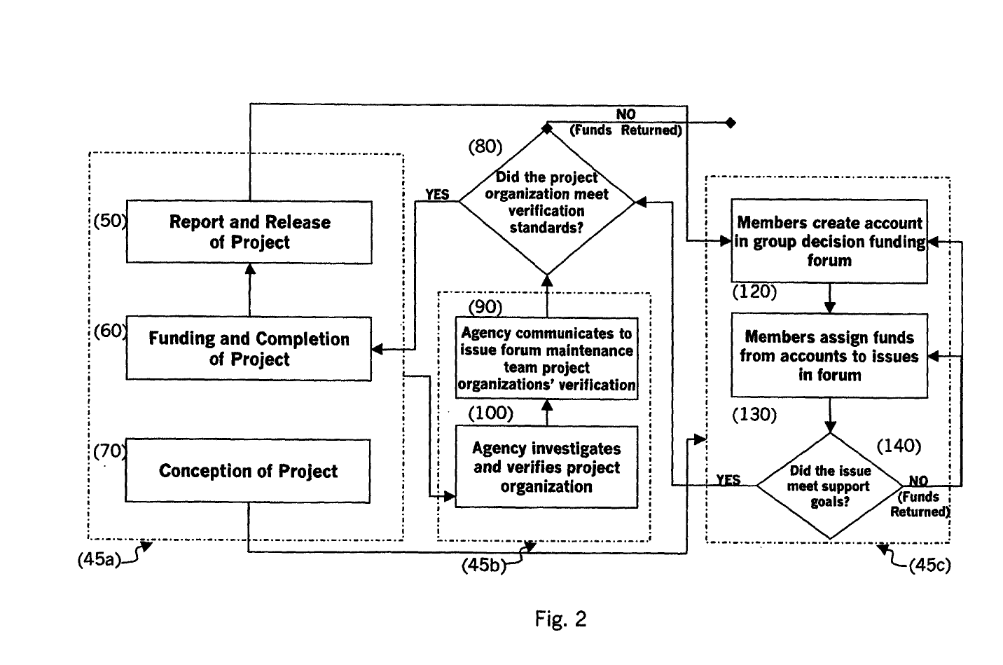

FIG. 2 depicts a block diagram of a preferred embodiment of a fundraising method of the present invention used by a group decision forum. This method comprises three general areas as depicted which are the project organization 45a (organization which defines and promotes the project for funding), the certification agency 45b (which verifies the stated requirements of the project organization), and the group decision forum 45c (where the projects are posted and funded). The project is conceived (70) by an organization that will promote and complete it once it is fully funded (60). Once conceived, the project is placed on the issue forum to gather support from users of the forum.

The project is placed on the forum by communication of the complete issue from the client machine, where client refers to a user of the site. The issue is then captured by a general Internet server software package that relays the message to a back end database or several back end databases. The issue is added to the database(s) where records are kept regarding the state and condition of the stated issue. A mechanism that interfaces between the database(s) and the Internet site maintenance routines will transfer relevant information about the new issue between mechanisms. The issue is then added to the Internet site, at which time it is considered active and may accept support.

In order to support an issue, a user (or member) creates an account (120) on the forum. An account is added by interfacing with the database(s) that store(s) and manage(s) information from individual users of the site. This (these) database(s) may cause the user to meet certain requirements and provide certain information before a new record is added to the database(s). Such requirements are not significant to the present invention.

A user account provides the user with the means of participating in any group action on the site. The user account may be created either with funds within it or he may move funds from an account through electronic means. The means through which the funds are transferred to the user account are insignificant to the present invention except that it shall be transferred through an electronic network such as the Internet. The funds are made available to the user for use on different group decisions listed on the Internet site. The transfer of funds into a user's account causes a record to be made of the transfer and the user's personal account information is then updated to reflect the account increase. At the same time, the same amount of funds added to the user account are electronically transferred from an external user account into an account maintained by the maintenance team of the holders of the present invention.

Once the account has received sufficient funds from an external account, the user may assign funds to a particular issue (130) on the forum. Assignment comprises a two-stage method. The first step in supporting an issue is for the client to identify himself through at least a username and password to the database. Once identified, the user supports issues by directly transferring funds into a committed form within his account. The funds are held there until the issue closes, successfully or unsuccessfully.

When an issue closes, the funds committed to it are gathered together using an accumulation mechanism (not shown) that transfers the funds from a committed state in individual users' accounts into a fund awaiting disbursement to the issue posting organization. An issue closes in the following manner. At each predetermined point (i.e., when someone adds funds to the issue or a scheduled time) the total is checked against the required funding amounts (140). If not reached, then the contributions are refunded to the contributing members. If the total goals have been reached, the forum operators check the posting organization for (80) attainment of verification requirements. The verification may also be conducted before or during the funding stage.

Verification requirements may be anything, from experience in the represented field of activity to a corporate status or the status of internal personnel, etc. These requirements act as statements about the organization that informs the supporters that the organization can and will complete the project that they are addressing. An organization is verified (100) through a process in which the verification goals are stated when the issue itself is posted on the Internet site. These goals are then communicated (90) to a verification agency that investigates the status of an organization and compares the investigation results against the stated results included in the issue. If the results are that the organization has met all of the stated requirements (80), the funds are disbursed to the posting organization (60) which completes and reports on the completion of the project (50).

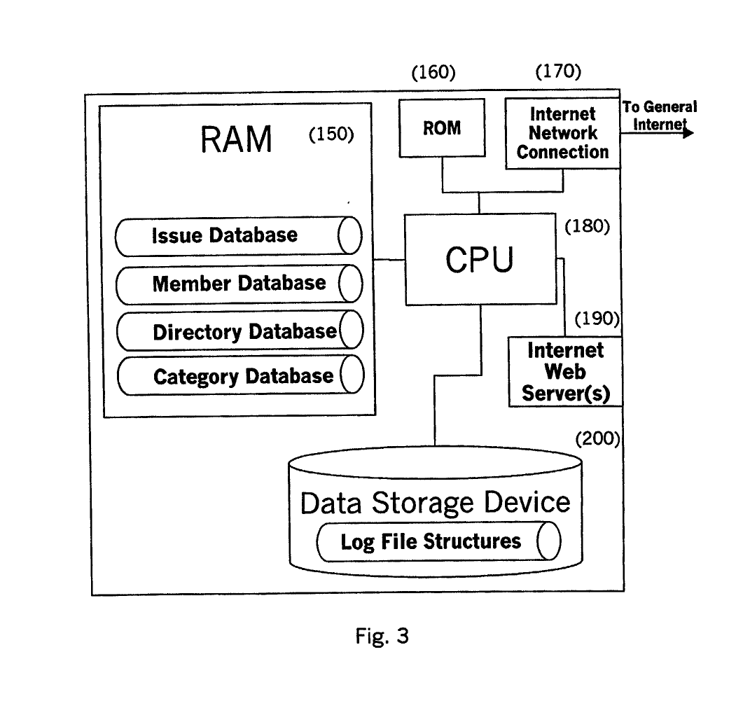

FIG. 3 illustrates a high-level system diagram of a typical hardware configuration used to implement the concepts of the present invention, including a general purpose Internet-enabled server that provides a group decision forum and service in accordance with the present invention. It comprises a number of components, the implementation format of which is not relevant to the present invention. The function of these components, however, determines the present invention and so they are mentioned here. In some cases, FIG. 3 shows specific implementations that can be substituted for other implementations as necessary.

The hardware that implements the Internet server comprises a number of specific components. It must have a general CPU (180), related RAM (150) and ROM (160) hardware for read only and random access memory operations respectively. It also comprises a physical connection to a computer network. An example of the hardware (170) that will allow such a connection is an Ethernet card with physical attachment to a network that is part of the Internet or other public or private network. The computer will have implementations of several databases. FIG. 3 shows exemplary databases which include the member database, the issue database, the directory database, and the category database. The member database stores member data about the members of the forum, including, but not limited to, the member's name, address, external account information, contact information, and historical transaction information such as issue posting and funding activity. The issue database stores information associated with the issues currently posted within and/or previously posted within the forum. This information may be referred to as issue data. For each issue this may include, but is not limited to, the issue specifics, the present status of the issue, the closing time and date, the support amounts (monetary or otherwise), an issue title, an issue summary, an issue goal, a verification ranking of the organization which posted the issue, and a research tip (e.g., a website link, a phone number, an address, a publication, a referral organization, or any combination thereof) to facilitate gathering of additional information regarding the issue-posting organization. The directory database is an electronic database containing a record of member transactions and support records within the group decision forum. The category database contains a description and hierarchy of categories that form the forum. There may be additional databases that support the present invention, but the aforementioned databases are required in a preferred embodiment of the present invention to ensure the most efficient operation of the site in group decisions.

The data storage device 200 contains log files (storage files that can be used to reconstruct the Internet site state). The log files are placed in system-safe non-volatile memory such as an internal or external fixed disk, although the exact form is not specified for the present invention.

The computer system also comprises one or more Internet servers 190 that function as an interface between the users of the group decision forum and the back end database structures and processing routines. The Internet server(s) 190 provide the basic bi-directional Internet traffic required to access and participate within the Internet site.

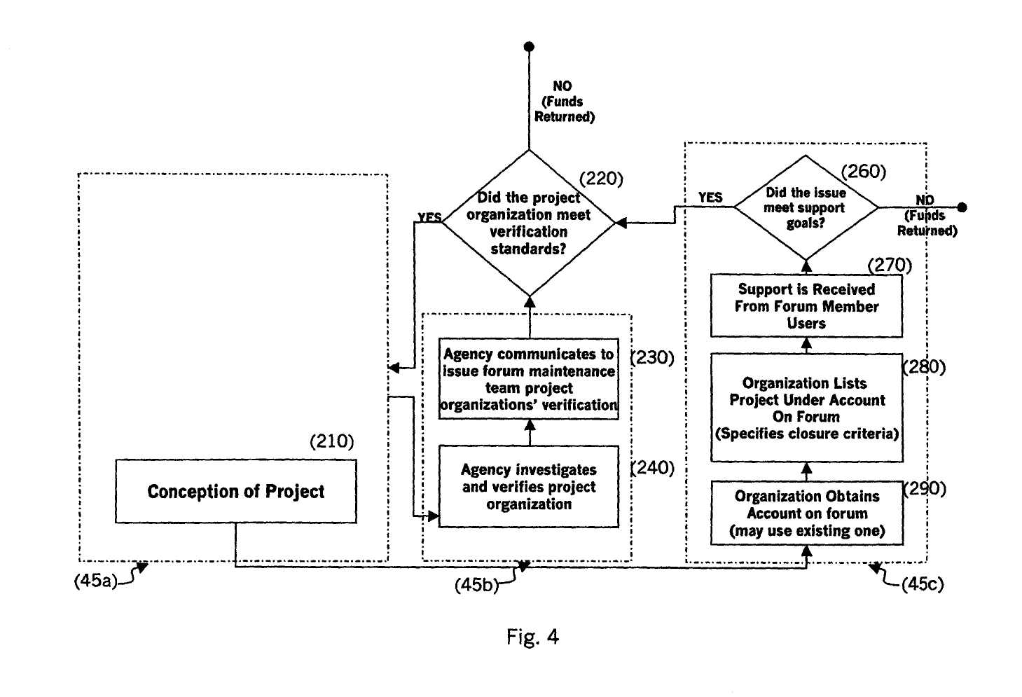

FIG. 4 shows the functional conception of a project within the framework and apparatus of a group decision forum of the present invention. The general makeup of the forum and process is introduced and shows a specific methodology for proposing and funding specific issues within the forum. In this manner, we examine the funding process from the perspective of the issue posting organization in order to further describe the present invention.

An issue is first conceived by the issue posting organization and developed into a coherent request for participation by the organization (210). In order to do something with the issue, the organization creates an account within the forum (290). When this account is created on the site, it can be used in a number of ways. These applications may contain, but are neither required nor limited to, various issue types, such as surrogate, representative, and personal postings of issues. A personal posting is simplest, referring to a posting placed on the group decision funding forum and completed by the same person. A representative issue refers to one that is placed on the site by a representative of the organization that will complete the project. A surrogate issue shall refer to issues that are placed by an individual that is asking for support so a separate organization can complete the project. In any case, the account is added (290) in the name of an individual, representative of the organization, or interested issue supporter. One example of a surrogate issue is where the issue involves raising funds to support the initial costs of developing a product which thereafter has close to zero marginal costs, typically through a large amount of very small contributions.

Once the issue has been specified (280) and an account is created (280), it is selectively added to the issue forum (posted) through the Internet access provided using the Internet server or equivalent technology. The issue then accepts support (270) from users of the group decision funding forum. When the issue is placed on the forum, it is posted with a stated goal and a verification requirement that is included with the posting. This set of verification criteria is communicated to a verification agency (240) for processing. In the meantime, the issue remains on the site until it is funded or has timed out. If the issue does not receive the proper support before the allotted time to gather support elapses, as checked at 260, it closes unsuccessfully and all support is returned to the issue supporters.

If the issue closes successfully, the issue posting organization is typically required to prove that they can meet all of the verification criteria within whatever timeframe is implemented on the group decision forum (220). If the posting organization can be verified within this period of time, the gathered funds (or equivalent) are then transferred to the posting organization (205). If the posting organization cannot meet the verification requirements, the funds will be transferred back to the individual accounts from where they were collected.

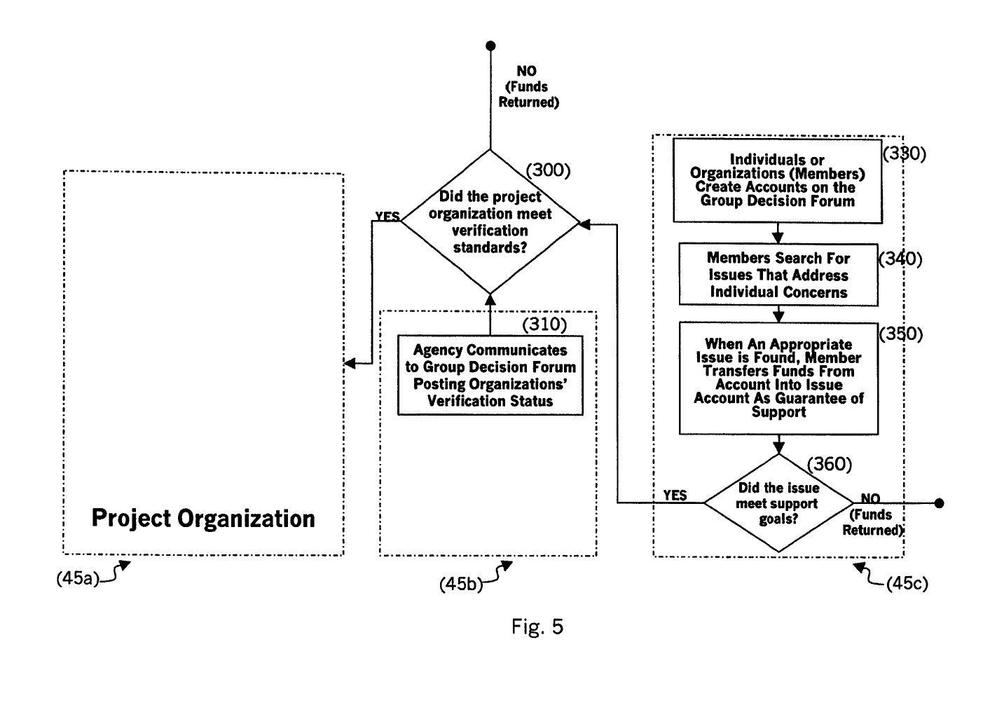

FIG. 5 takes a look at the same funding process from the perspective of a user of a group funding forum in accordance with the present invention. Such a user is a participant in a group decision through the format that is discussed within FIG. 5 . From the perspective of a user, issues simply exist on the forum. A user shall not be interested, when supporting issues, in the mechanisms with which issues are added to the site. Rather, they concern themselves with the mechanisms provided for supporting the issues.

From this viewpoint, a user is one of a large group of individuals that are participants in funding drives on the site. The user will generally use his Internet browser or equivalent technology to look through the site in search of issues that address his areas of interest (340). Once he finds an issue, or otherwise wishes to participate in the funding process as a member, the order of activity being inconsequential to the present invention, he creates an account on the site (330). In doing so, he instructs the server to create a record within the member database that is accessible through the group decision forum network interface technology. This record contains the information typically necessary for the user to participate in actions on the site. The user may create the account with or without funds having been deposited in his account. After creating the account, he returns to or find issues that he wishes to support and commits funds residing in his account to the project using forum defined mechanisms for doing so (350). These funds are stored in a committed form within his account until the issue closes. Whether or not the support amount is restricted (in amount or by number of support instances) is not relevant to the present invention. Once the issue closes, if the closure was successful (all support was gathered) the posting organization's verification requirements are checked(300). If the closure was unsuccessful, any funds that a member transferred to the issue will be returned to his free funds section of his account. Typical verification requirements are discussed in regards to previous or subsequent Figures. Once the issue is successfully closed and the verification requirements are met, the funds are removed from a committed state within the users' account and transferred to a holding account for disbursement to the posting organization, as previously described, or for temporary staging while further verification of the issue-posting organization completes.

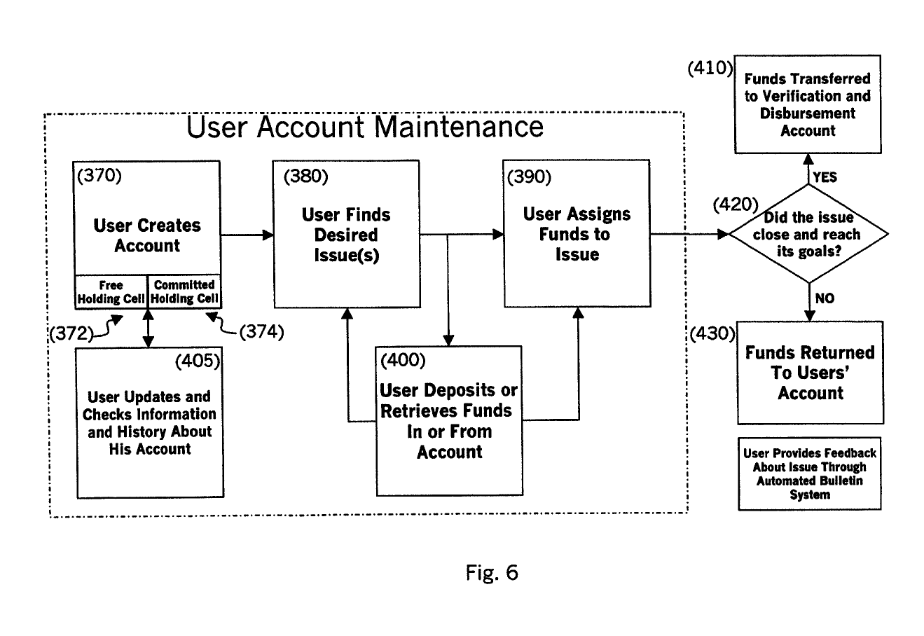

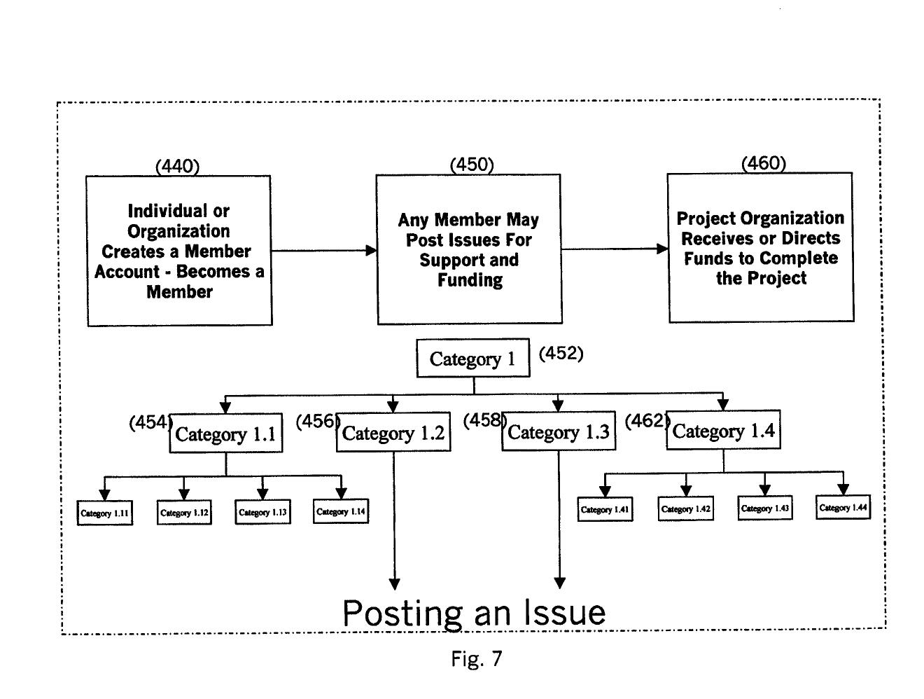

FIG. 6 shows the different processes and mechanisms available to the user to maintain his account. A user account is first established (370) by requesting an addition of an account to the member database through a client browser or equivalent and the public or private network system. Opening the account may or may not be subject to various requirements including, but not limited to, the depositing of a set amount of funds to the account. The account comprises a location 372 for the depositing and use of “free” uncommitted funds and a second location 374 for “committed” funds.

Once the user has an account within the group decision forum, he may find issues that address his areas of concern (380). He may then (upon identifying himself to the system) support them by transferring funds from his account (390) to a committed holding state for the issue(s). If he desires his deposited funds back or needs to increase the available funds within his account (400), he may transfer funds from an external account into his forum account. These funds are available to the member for use on the forum through his account. In the same manner, the member may transfer funds from his forum account to an external account, where the external account is the same account that was used to initially place money on the account. There may be other restrictions as well.

The user has a mechanism to update key informational elements regarding his account (405). These include, but are not limited to, the first name, the last name, the mailing address, and external account number and expiration date. External account number changes may or may not be restricted when there is an active balance in a user account to keep this system from being used as a separate payment mechanism.

When funds are committed to an issue, they are held in the user's account in committed form until the issue either closes successfully (410) or unsuccessfully (430), as checked at 420. During the course of use of the group decision forum, the user may access a specific database to check his history (405) of activity within the forum. This activity provides information about the issues that the user has supported to that date, in order of most recent to most dated activity.

FIG. 7 discusses the method and apparatus required to add an issue to the group decision forum. This Figure discusses this issue from the perspective of a user of the forum. For the first step, the user opens an account on the group decision forum (440). The account may be used as an individual account or as a group account, depending on the owner of the account. There may or may not be further information requested to open a corporate account as opposed to a personal account.

The user identifies a proper category in which to place the issue. In order to facilitate this placement, the categories that accept and display issues in order to gather support are preferably arranged in a hierarchical structure , for example one commonly known as a tree structure as seen in FIG. 7, which shows category 452, its children categories 454, 456, 458, and 462, and their children categories. The user shall peruse these structures to find an appropriate category in which to place his issue. Generally this choice should be related to the type of people that will look through that category; these individuals should be the most likely supporters of the issue itself.

Once the account has been created and an appropriate category has been chosen, the user will use the group forum issue posting interface to instruct the issue database to add a specific issue (450). This issue will be added to the issue database with an initialized state. From then on, the group decision forum shall mechanically add the new issue to the forum without further intervention by non-mechanized systems. The issue may begin accepting funds from the time that it appears on the Internet forum, although the timeframe shall not be consequential to the statement of the issue. Each issue is kept updated with regards to a present support amount. An issue is assigned a timeout date in which it must obtain its posted support. If any issue fails to receive its posted support amount before its permitted time elapses, it closes unsuccessfully and all funds are returned to the issue supporters. If it receives the required support, it closes successfully (460).

When an issue closes successfully, the group decision forum notifies the posting individual to finalize disbursement details. The nature of the contact may be by any of a number of means available to the group decision forum personnel.

Turning now to the components of an issue, the following components typically define a complete issue posted in the group decision forum:

Issues contain a title, a summary, and a discussion to describe what is proposed for support (470).

Issues contain the number and/or value of support required to successfully close this issue and the individual support requirements (480).

Issues may be posted by a member as an individual, as a member of the organization for which it is being posted (i.e., an officer of a company), or as an issue that one hopes a certain unaffiliated organization will accept and complete (i.e., an issue to fund a political action committee for lobbying in the present election). In the first of these cases, the issue is referred to as a personal issue. In the second case, it is called posting an issue representative. The final case is called posting an issue surrogate (490).

Issues may be posted with or without any required verification. Verification is used to indicate that the organization is judged by an outside group of being able to complete the stated project (500) and existing as an entity as represented in the issue statement.

There may be specific components to an issue—as listed above. For example, the title is used to announce or introduce the issue to the users. A summary is provided as a brief description of the project for those that are interested in a synopsis before committing to an issue. The discussion gives the specifics about the issue—what is to be completed, by whom, and when and where it will be completed. In addition, the user typically specifies the amount of support (and type of support) that must be raised to complete the issue.

The issue posting organization is not required to be included. In many cases it may not be required for an organization to be verified because of a prevalence of support that they can raise without the need to be verified for anything. However the verification level is a predefined statement about the posting organization that is included with the issue from the start of the issue drive. It may, for instance, contain the corporate status of an organization or conditions that a community group will meet before the money is disbursed. In any case, the issue posting individual will include the verification standard that he chooses in the definition of the issue. The disbursement of funds, then, require that the organization meet these standards as stated on the issue before the funds are disbursed. If the standards are not met by the issue posting organization, all funds are returned to the supporters.

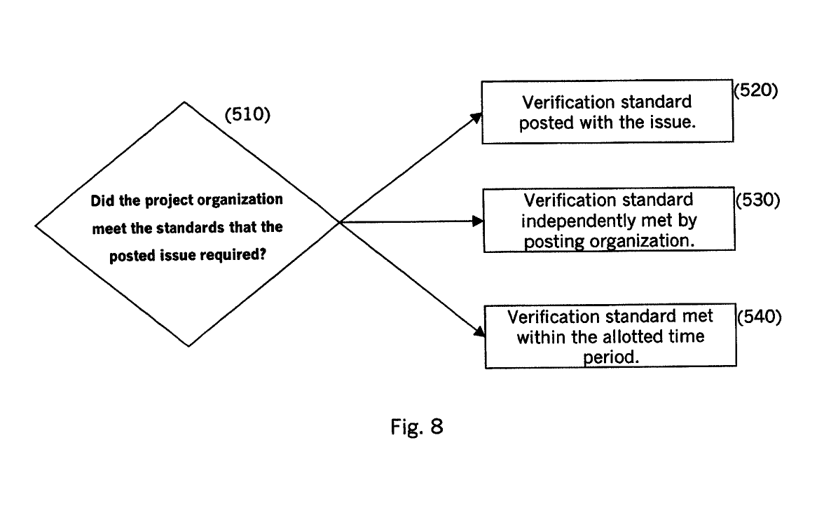

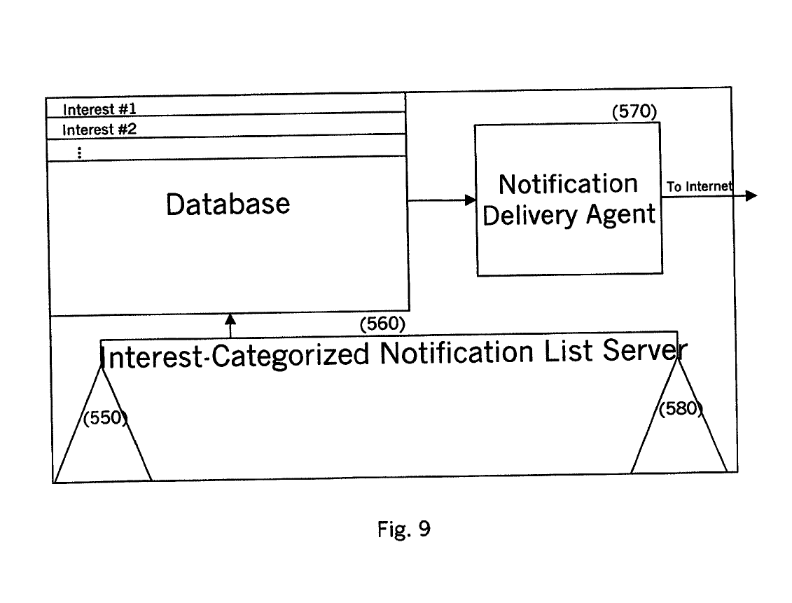

Turning now to FIG. 8, typical verification standards are seen in a bit greater detail than earlier Figures. As shown at (510) in the verification of posted standards, the posting organization typically does three basic things.

At 520, the organization posts the standards on the Internet site together with the issue at the time of placing the issue. The level chosen is purely voluntary but typically must be met once the issue closes. Since the users may desire the organizations to meet certain criteria in order to support them, it is advisable to include as large a verified standard as possible.

Once the issue closes or any time earlier, the posting organization at 530 is required to meet the standards placed on the Internet site. This compliance is verified and stored on internal verification databases provided by the group decision funding site.

Funds gathered for a successfully completed issue need not be held indefinitely pending satisfaction of the posted standards. The group decision funding site may impose a time limit by which an organization may comply with the stated funding standards as seen at 540. If the standards are not met before the timeout period, the funds will be returned to the accounts of the users of the site.

Turning now to FIG. 10, there is shown the general apparatus for the group decision message delivery agent, which is a preferred, but optional component of the present invention. This technology enhances the power of the group decision forum because it provides the outward information flow that keeps users of the site informed about activity on the site. In order to create this powerful arm of the service, the service employs a categorized mail list that contains users listed through their message address and categorized by interest. The interest categorized message delivery agent server (ICMDAS) is a message delivery agent and a back end database that lists and manages messages and associated message data, informing users of activity that occurs in their interest categories. The message delivery agent thus typically maintains a plurality of delivery addresses, and at least one corresponding area of interest associated with each of the delivery addresses.

The ICMDAS is typically systematically created from two software constituents and two input locations into the system. The first component is the message delivery agent itself (570) which delivers inexpensive and timely notification of activity or opportunity for involvement with issues or discussions occurring on the site. It is preferably configured to take commands from the database system (560) only, barring direct access from operators on the mail platform.

The database system (560) contains the categorized message addresses, and the contact information from the database system as updated by the group decision database systems. This database manages automated contacts with the people opted into the lists concerning the lists they are involved in. It also manages messages requesting addition to or removal from any message list that exists within. The database system interfaces with the message delivery agent to give the group decision funding forum the ability to reach out and build participation and notification about specific issues or subjects of interest on the Internet site.

The database system typically has two input interfaces in addition to the automatic email response manager that handles email requests. These interfaces are the user (550) and operator (580) interfaces. The user interface (550) is a method and apparatus through which requests for addition to the categorized email lists are received from a public or private electronic network system. These requests are handled by adding these email addresses to the specific named categories that have been requested. In addition, the operator can alter two things within the database. The present invention provides the operator with the tools to add email addresses to the categorized email lists. It also includes the tools necessary to receive, for disbursal, either general information messages that go out to all of the email accounts in the entire system, or directed messages that are sent out to a specific genre of recipients. These tools may include a mix of automatic and manual tools to provide a high degree of very powerful outgoing directed messaging to support the operation of the group decision forum.

The present invention now being described, it will be clear to anyone ordinarily skilled in the art that many changes and modifications can be made thereto without departing from the spirit or scope of the appended claims.

What is claimed is:

1. A system for enabling a plurality of members to support a group decision by communication over a computer network, said system comprising:
a network server; and
computer software controlled by the network server, and programmed to:
a) present a funding forum to the plurality of members, said funding forum comprising an interface which facilitates a first member in posting a first issue within the forum for support from other members, and committing support to a second issue posted within the forum by a second member; and
b) receive, process, and manage member data, message data, and posting data associated with the plurality of members; and
c) receive, process, and manage issue data associated with the first and second issues.

2. The system of claim 1, wherein the interface further facilitates each of the plurality of members selectively posting corresponding issues within the forum for support from the other members.

3. The system of claim 2, wherein the corresponding issues are presented in a hierarchical structure.

4. The system of claim 2, wherein the member data comprises a plurality of accounts corresponding to the plurality of members, and wherein each of the plurality of accounts comprises a corresponding free portion representing funds not committed to any particular one of the issues, and a corresponding committed portion representing funds committed to particular ones of the issues.

5. The system of claim 4, wherein the interface further facilitates each of the plurality of members transferring funds between the corresponding free portion and committed portion of their respective accounts.

6. The system of claim 4, wherein the issue data associated with the first issue comprises an end date, and wherein the software is further programmed to stop receiving funds for the first issue after the end date.

7. The system of claim 6, wherein the software is further programmed to transfer funds associated with the first issue, from the committed portions of the accounts to the corresponding free portions of the accounts, after the end date if a predetermined total funding goal is not attained.

8. The system of claim 4, wherein the first issue has a holding account associated therewith, and wherein the system is adapted to process a transfer of funds from the corresponding committed portions of the accounts to the holding account in response to a predetermined total funding goal being attained.

9. The system of claim 1, wherein the issue data associated with the first issue comprises an issue title, an issue summary, an issue goal, an issue-posting organization verification ranking, and a research tip.

10. The system of claim 1, wherein the interface further facilitates the first member in establishing an issue type associated with the first issue.

11. A system for enabling a plurality of members to support a group decision by communication over a computer network, said system comprising:
a network server; and
computer software programmed to present an issue-based funding forum which facilitates posting of issues by the members and funding of the issues by the members, and management of issue data associated with the issues, and member data and posting data associated with the members, and making the issue data and posting data available for retrieval by the members;
wherein the software is controlled by the network server.

12. The system of claim 11, wherein the funding forum further facilitates verification of information associated with a member who posted a first issue, and assignment of a rank to the member for association with the first issue.

13. The system of claim 12, wherein the funding forum further facilitates management of message data associated with the members by use of a message delivery agent.

14. The system of claim 13, wherein the message delivery agent maintains a plurality of delivery addresses and corresponding areas of interest associated with each of said plurality of delivery addresses.

15. A method of enabling a plurality of members to support a group decision by communication over a computer network, comprising the steps:
providing an issue-based funding forum accessible to the members by use of the network;
receiving a request from a first member through the network to post a first issue on the forum;
executing a posting transaction in response to the request of the first member, said posting transaction posting the first issue on the forum for funding, and assigning an account to the first issue;
receiving a request from a second member through the network to fund the first issue; and
executing a credit transaction in response to the request from the second user, said credit transaction transferring funds from a free portion of an account associated with the second member, to a committed portion of the account associated with the second member, and associating the transferred funds with the account assigned to the first issue.

16. The method of claim 15, further comprising the steps of:
receiving a plurality of requests to place a corresponding plurality of additional issues on the forum;
posting the additional issues on the forum in response to the plurality of requests; and
presenting the plurality of issues within the forum in an issue-based hierarchical structure.

17. The method of claim 16, further comprising the steps of:
maintaining a plurality of delivery addresses and corresponding areas of interest associated with each of said plurality of delivery addresses; and
using the areas of interest to form the issue-based hierarchical structure.

18. The method of claim 15, wherein the account assigned to the first issue comprises a free portion and a committed portion, and is associated with the second member, and wherein the credit is entered into the free portion.

19. The method of claim 18, further comprising the step of transferring the credit from the free portion of the account to the committed portion of the account in response to a request from the second member.

20. The method of claim 15, further comprising the step of verifying information associated with the first member, and assigning a verification status to the first member for association with the first issue.
